(19) United States
(12) Patent Application Publication
(10) Pub. No.: US 2012/0150993 A1
(43) Pub. Date: Jun. 14, 2012

(54) ASSISTED DELIVERY OF CONTENT ADAPTED FOR A REQUESTING CLIENT

(75) Inventors: Martin T. Flack, Boston, MA (US); Eric L. Kobrin, Cambridge, MA (US)

(73) Assignee: AKAMAI TECHNOLOGIES, INC., Cambridge, MA (US)

(21) Appl. No.: 13/281,615

(22) Filed: Oct. 26, 2011

Related U.S. Application Data
(60) Provisional application No. 61/408,530, filed on Oct. 29, 2010.

(51) Int. Cl. G06F 15/16; H04W 4/00

(52) U.S. Cl. 709/217

(57) ABSTRACT

Disclosed herein are methods and apparatus facilitating delivery of web content that has adapted for particular client devices, such as mobile devices. Doing so may involve assisting a server without the adaptation logic necessary to deliver adapted content to a particular client device. For example, a given web server may adapt content and serve website content to a requesting client, but another server may take over when the client desires to make a purchase at the site. That other server, while perhaps qualified to process payment information, may not be able to provide adapted content. The content adaptation web server can assist that other server to do so. In other embodiments, such a content adapting server may provide such services to a range of other servers, and itself may not serve content directly to the client. The teachings herein may be implemented within a content delivery network.

### CROSS REFERENCE TO RELATED APPLICATIONS

This application claims the benefit of priority of U.S. Provisional Application No. 61/408,530, filed Oct. 29, 2010, the contents of which are hereby incorporated by reference.

### TECHNICAL FIELD

The present invention generally relates to the delivery of content that is adapted for particular types of clients, such as mobile devices.

### DESCRIPTION OF THE RELATED ART

Delivering suitable content for mobile clients presents challenges. One approach for delivering content uses transcoders, which take in content (e.g., an image on a web page) and transform or adapt that content into a format suitable for the display and data transmission capabilities of a mobile device. A variety of adaption/transcoding algorithms are known in the art. Exemplary approaches for transcoding content are described in U.S. Pat. No. 7,047,033 and U.S. Patent Publication 2003/0115365, the teachings of both of which are hereby incorporated by reference. Transcoding of image, video, and other content is described in Bharadvaj, Joshi et al., “An Active Transcoding Proxy To Support Mobile Web Access,” Reliable Distributed Systems, Proceedings of 17th IEEE Symposium on Reliable Distributed Systems, pp. 118-123 (1998), the teachings of which are hereby incorporated by reference.

During a browsing session, a mobile client may interact with more than one server. Indeed, it may be desirable or necessary to have separate servers—or perhaps a set of separate servers—communicate with the mobile client and/or act in concert during a session. For example, for an e-commerce website, web content generally may be served by a given server that mobilizes content for the client. However, on certain parts of the site, payment forms or other sensitive/confidential information (e.g., account data, credit card data) may be involved. Such content may be handled, and that portion of the site served, by another server. This may be done because the information may be subject to any of a variety of standards (e.g., Payment Card Industry Data Security Standard, PCI-DSS) that mandate the use of certain encryption and other data protection techniques in order to hold and process that information. The general-purpose given server may not be qualified for such tasks. Similar situations can arise in the context of online financial transactions, order management, or secure account access, or other scenarios in which a special-function server is needed for part of a website visit.

Similar issues may arise where the delivery of Internet content takes place in a distributed computer system such as a “content delivery network” or “CDN” that is operated and managed by a service provider. The service provider typically provides the service on behalf of third parties. The third parties may run an origin server from which the CDN pulls content to deliver to requesting clients. A “distributed system” of this type typically refers to a collection of autonomous computers linked by a network or networks, together with the software, systems, protocols and techniques designed to facilitate various services, such as content delivery or the support of outsourced site infrastructure. Typically, “content delivery” means the storage, caching, or transmission of content, streaming media and applications on behalf of third party content providers, and may include ancillary technologies used therewith including, without limitation, domain name service (DNS) request handling, security, provisioning, data monitoring and reporting, content targeting, personalization, and business intelligence. The term “outsourced site infrastructure” typically means the distributed systems and associated technologies that enable an entity to operate and/or manage a third party's Web site infrastructure, in whole or in part, on the third party's behalf. Hence, a CDN server may be serving some content to the mobile client, but an origin server may be serving other content to the mobile client.

From the perspective of the client, the browsing experience is ideally consistent throughout in such multi-server scenarios—meaning that content ought to be adapted in a consistent way. Accordingly, there is a need for adaptation of content for clients across such multiple servers.

It is an object of this invention to provide, in certain embodiments, methods and apparatus for delivering adapted content to clients, both mobile and otherwise, when such content comes from different servers.

It is a further object of the invention to provide, in certain embodiments, methods and apparatus that enable a server without the capability of adapting content to be able to serve adapted content to a particular client, e.g., a mobile client.

It is a further object of the invention to provide such methods and apparatus for delivering content to clients as will be described below.

### SUMMARY

The methods and apparatus disclosed herein facilitate delivery of content such as web pages, images videos, and the like, to clients. More specifically, many of the methods and apparatus facilitate the delivery of content that has been “mobilized” by being adapted to the mobile-specific characteristics of (and/or limitations of) a mobile device. The principles disclosed herein have particular, though not exclusive, applicability in the realm of multi-server delivery of content, in which the delivery of mobilized content to a given device must take place across multiple servers, all of which may not be equipped for doing so. For example, one web server generally may adapt content (e.g., mobilize it) and serve website content to a requesting mobile client, but another server may “take over” when the mobile client desires to “check out” and make a purchase at the site. That other server, while perhaps being qualified to process payment/order/personal information, may not be able to provide adapted, mobilized content, or at least may not be able to mobilize content in a way consistent with the content adaptation server. As described herein in certain embodiments, the content adaptation web server may provide services to that other server to enable it to serve mobilized content. In other embodiments, such a content adapting server may provide such services to a range of other servers, and itself may not even serve content directly to the mobile client.

Many of the methods and apparatus disclosed herein may be implemented in conjunction with a content delivery network (CDN) having a plurality of distributed content servers. For example, a server providing mobilization services may be a CDN server.

It should be understood that the methods and apparatus disclosed herein may be applied to any device with differentiated or limited capabilities in terms of display, processing, form factor, intended deployment. While a mobile device such as a smartphone or tablet are some examples of this and are used for illustrative purposes throughout this disclosure, adapted content can also be delivered to other client devices such as gaming systems, televisions, e-readers, and so on, in accordance with the teachings hereof.

By way of example and illustration, in one aspect of the invention, a method for delivering content to a mobile client can proceed as follows. In response to a request for content from a mobile client at a first content server, the first content server can send to a second content server a request for information that can be used to provide the requested content to the mobile client in a format adapted for display by the mobile client (for convenience, referred to as “mobilization information”). Such information can include, for example, information identifying the mobile client or one or more characteristics thereof, such as a mobile operating system, browser, screen size, screen resolution, support for particular multimedia technologies/formats or software versions, and so on. The mobilization information can be generated by the second server based on one or more characteristics of the mobile client. It may be created in real-time by the server, or looked up in storage, etc. The mobilization information can be sent to the first content server, so as to enable the first content server to provide the requested content to the mobile client in a format adapted for display by the mobile client. The mobilization information may take many forms, but for example it can be a template which the first content server can populate to form a complete response for the mobile client.

Note that the second content server, in addition to providing such mobilization information, may also receive and respond to requests for content from the mobile client directly. In doing so, it may need to adapt the content for the mobile client, again based on the characteristics of the mobile client. The second content server may also have the ability to retrieve the original, un-adapted content from the first content server or another server, e.g., in the manner of a caching proxy server in a CDN.

By way of further illustration and example, in another aspect of the invention, there is provided a method for delivering content to a requesting mobile client via a content delivery network (CDN), with the CDN delivering content on behalf of a plurality of content providers associated with origin servers. The method may include receiving a first request for content from a mobile client at a CDN server (e.g., a cache server or otherwise), the first request including information identifying the mobile client or one or more characteristics thereof. The CDN server can be used to obtain content responsive to the first request, adapt the responsive content into a format adapted for display by the mobile client, based on one or more characteristics thereof; and serve the adapted content to the mobile client. Further, the CDN server can receive a second content request from the mobile client and—upon detecting that the origin server should respond to the mobile client rather than the CDN server—redirect or otherwise have the origin server receive the second request. Further, the method can include receiving, from the origin server that is now responding to a second request for content from a mobile client, a request for information that can be used to provide the requested content to the mobile client in a format adapted for display by the mobile client (“mobilization information”), the request for mobilization information including information identifying the mobile client or one or more characteristics thereof. The CDN server generates the mobilization information based on one or more characteristics of the mobile client, and sends the mobilization information to the origin server, so as to enable the origin server to provide the requested content to the mobile client in a format adapted for display by the mobile client.

In yet another aspect of the invention, a method for delivering content to a mobile client can include receiving a first request for content from a mobile client at a first content server in a given session, the request including information identifying the mobile client or one or more characteristics thereof. Content responsive to the first request is obtained and adapted for display by the mobile client, based on one or more characteristics of the mobile client. The first content server serves the adapted content to the mobile client. Further, state of the given session is transferred from the first content server to a second content server upon the first content server receiving a second request from the mobile client in the given session, that second request seeking content that reflects confidential information or indicates that confidential information will be provided by the mobile client. The state of the session typically reflects at least one previous communication between the first content server and the mobile client.

As those skilled in the art will understand, computerized apparatus and systems may be configured to implement the foregoing methods, consistent with the teachings herein, and instructions for performing such methods may be encoded on various kinds of non-transitory storage mediums. The foregoing embodiments are merely illustrative. Other embodiments, as well as further features and details, are described below.

### BRIEF DESCRIPTION OF THE DRAWINGS

The invention will be more fully understood from the following detailed description taken in conjunction with the accompanying drawings, in which:

FIG. 1 is a schematic view of one embodiment of a content delivery network;

FIG. 2 is a schematic view of one embodiment of a computing machine for use in the content delivery network shown in FIG. 1;

FIG. 3 is a diagram of three exemplary systems in which assisted delivery of mobilized content may take place;

FIG. 4 is a schematic view of an exemplary flow of data between servers and mobile clients;

FIG. 5 is a schematic view of a flow of data between servers and mobile clients in the context of a payment transaction;

FIG. 6 is an alternate schematic view of the flow of data of data between servers and mobile clients shown in FIG. 4, above;

FIG. 7 is a schematic view of an exemplary flow of data between servers and mobile clients in an architecture having a customer managed/selected environment;

FIG. 8 is a schematic view of an exemplary flow of data between servers and mobile clients in an alternate system architecture;

FIG. 9 is a schematic view of one embodiment of a computer system with which the apparatus and methods described herein may be implemented.

### DETAILED DESCRIPTION

The following description sets forth embodiments to provide an overall understanding of the principles of the structure, function, manufacture, and use of the methods and apparatus disclosed herein. The methods and apparatus described herein and illustrated in the accompanying drawings are non-limiting examples; the scope of the present invention is defined solely by the claims. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. It should be understood, again, that while having particular application in the context of content deliver to mobile clients, certain methods and apparatus disclosed herein may be implemented to deliver content to non-mobile clients.

1.0 Content Delivery Network

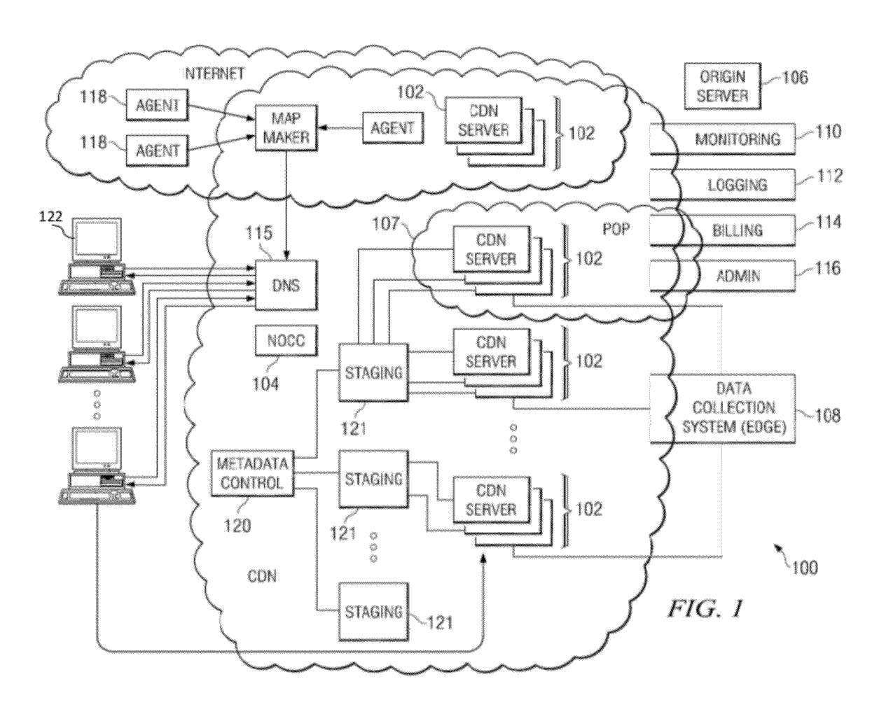

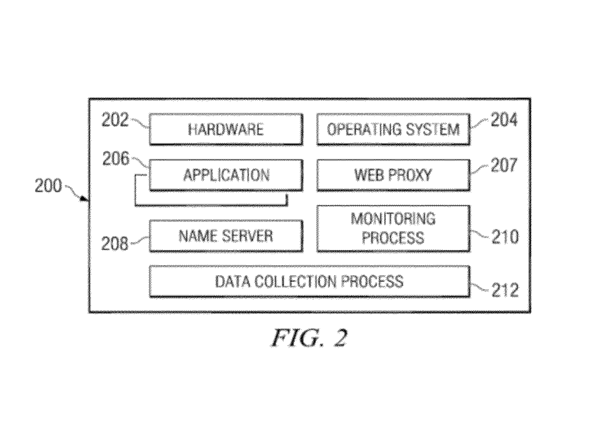

As will be explained in more detail below, the methods and apparatus disclosed herein may be implemented in the context of a distributed computer system, e.g., a content delivery network (“CDN”) as illustrated in FIGS. 1-2, although they are not limited to such implementations. A brief overview of an exemplary CDN architecture is now provided.

With respect to FIG. 1, a distributed computer system 100 is configured as a CDN and is assumed to have a set of machines 102 distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to content servers (also called “edge” servers as they are often located at the “edges” of the Internet) running on the machines 102. Typically, content providers offload their content delivery by aliasing (e.g., by a DNS CNAME) given content provider domains or sub-domains to domains that are managed by the service provider's authoritative domain name service, more details of which are set forth in U.S. Pat. Nos. 7,293,093 and 7,693,959, the disclosures of which are incorporated by reference herein. End users operating client machines 122 that desire the content are directed to the distributed computer system, and more particularly to one of its machines 102, to obtain that content more reliably and efficiently.

Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

As illustrated in FIG. 2, a given machine 200 comprises commodity hardware (e.g., an Intel Pentium or other processor) 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” or “ghost” process), a name server 208, a local monitoring process 210, a distributed data collection process 212, and the like. For streaming media, the machine typically includes one or more media servers, such as a Windows Media Server (WMS) or Flash server, as required by the supported media formats.

Client machines 122 include conventional personal computers, laptops, other digital data processing devices. Client machines 122 also include mobile clients, which may include any a variety of mobile devices such as cellphones, smartphones, or personal digital assistants (PDAs), running a client application (e.g., a web browser) which, e.g., issues requests for content from the servers, receives responses from the servers, and processes and displays the received content for a user.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057, the disclosure of which is incorporated herein by reference, illustrates a useful infrastructure for delivering and managing edge server content control information, and this and other edge server control information can be provisioned by the CDN service provider itself, or (via an extranet or the like) the content provider customer who operates the origin server.

The CDN may include a storage subsystem, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference.

The CDN may provide secure content delivery among a client browser, edge server and customer origin server in the manner described in U.S. Publication No. 2004/0093419, the disclosure of which is incorporated herein by reference. Secure content delivery as described therein enforces SSL-based links between the client and the edge server process, on the one hand, and between the edge server process and an origin server process, on the other hand. This enables an SSL-protected web page and/or components thereof to be delivered via the edge server.

2.0 Delivery of Adapted Content

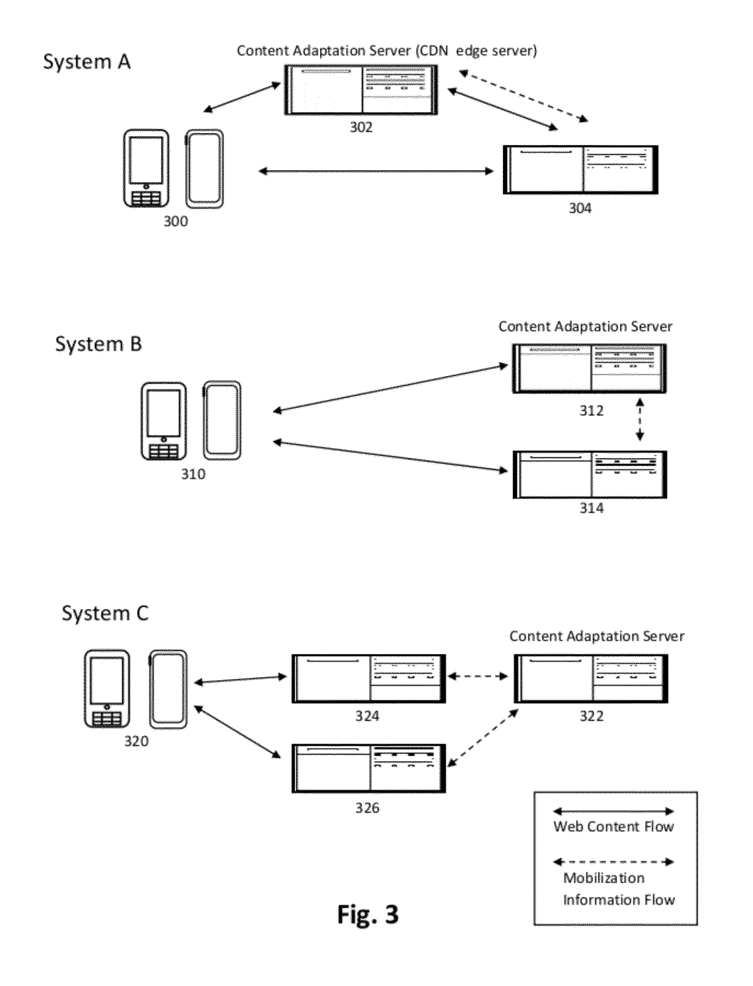

FIG. 3 illustrates, at a general level, three exemplary systems for delivery of mobile content. In system A, a mobile client 300 requests and is served content (e.g., html pages, images, multimedia, or other content) from an origin server 304 via a content adaptation server 302. In this case, the content adaptation server 302 is a content server in a content delivery network (CDN), and it may cache or otherwise facilitate the delivery of the content from the origin server 304, as described above and as known in the art. However, at certain times, the mobile client 300 interacts directly with the origin server 304. For example, as described above, the origin server 304 may handle certain functions such as payment processing, order management, account lookup or other functionality which may have special/secure requirements. Note that by doing so, the content adaptation server 302 need not be equipped or qualified to handle such interactions (it may need not be PCI-compliant, for example). During such interactions, the content adaptation server 302 can provide mobilization information services to the origin server 304 in adapting the content for the given mobile client, which is indicated by the dotted lines. Such services may include providing templates suited for the particular requesting mobile client, or other information, as will described in more detail below. Thus, according to embodiments described herein, the origin server can leverage the content adaptation server to consistently provide mobile-adapted content to the mobile client during a session.

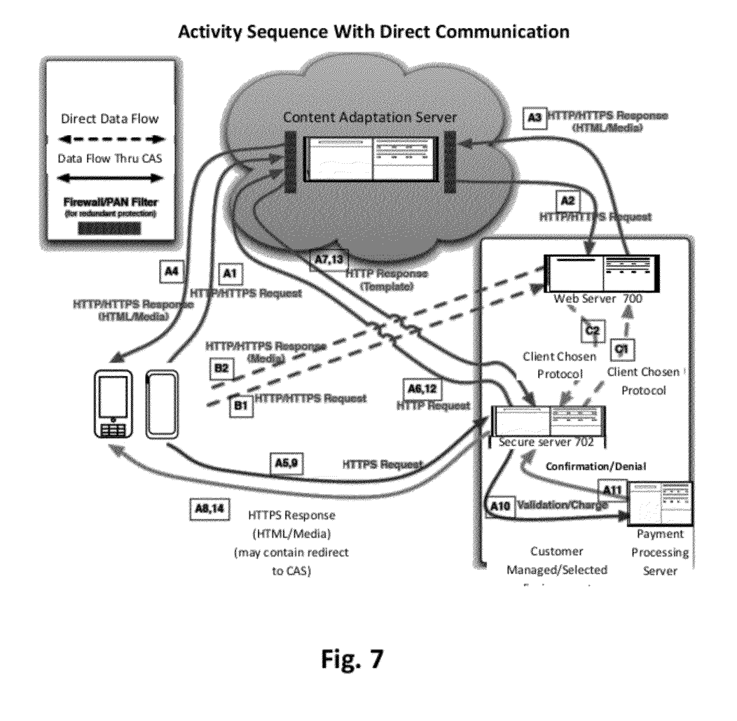

It should be noted that the origin server 304 in System A may in fact represent two different servers, one providing web content via the content adaptation server 302 and another that will interact directly with the mobile client at selected times (such as an payment processing server or order management server). This will be described in more detail below with respect to FIG. 7.

System B illustrates an alternate architecture which does not involve an intermediary server as shown in system A. In system B, the content adaptation server 312 provides website content and accordingly delivers requested content to the mobile client 310 as the ultimate source of such content—it does not go back to an origin server as the server in system A does. A payment processing or other special purpose server 314 also interacts with the mobile client at certain times. The content adaptation server 312 provides mobilization information to the server 314.

In system C, the content adaptation server 322 does not interact with the mobile client 320 at all, but supports delivery and provides mobilization information via services to various other servers 324, 326 that do interact with the mobile client 320. In some embodiments, servers 324 and 324 may be operated by website providers. In the embodiment of system C, these entities are customers who have subscribed to the mobilization service provided by the operator of the content adaptation server 322. The customer may be charged a fee for access to the content adaptation server and/or based on usage.

Upon determining that the requesting client is a mobile client (e.g., through examination of the user_agent string or other technique), the servers 324, 326 may request and receive appropriate mobilization information from the content adaptation server 322. The content adaptation server maintains a current library of templates or other information for existing mobile clients and is updated with new templates as new mobile clients are introduced. The servers 324, 326 uses the information to respond to the mobile client 322.

Hence, the content adaption server may play a variety of roles in the system, and may assist a variety of servers to deliver mobilized content. The teachings herein apply to all of these systems.

2.1 Data Flow

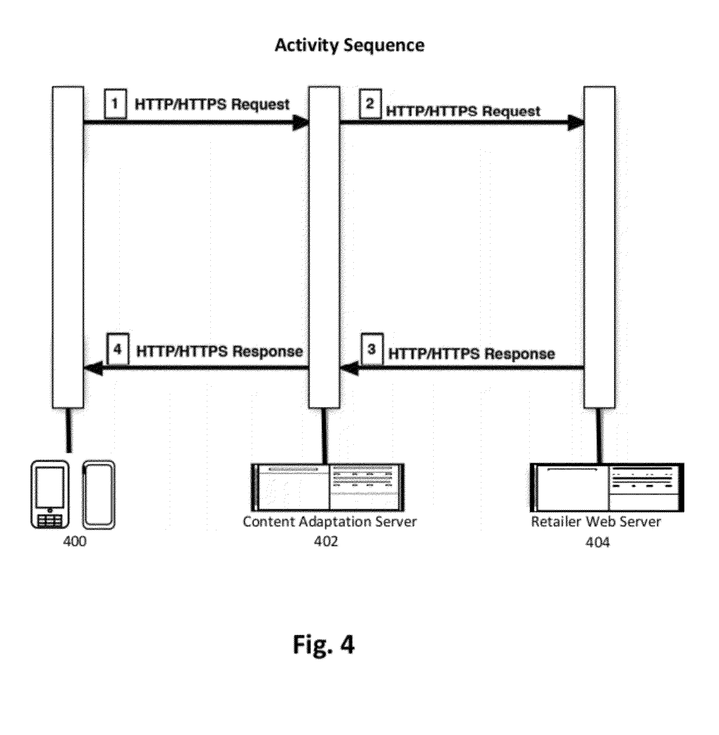

FIG. 4 illustrates a system similar to that of system A, described above. FIG. 4 shows a typical flow of information between a mobile client 400, a content adaptation server 402 and an origin server 404, which in this example is an origin server providing an e-commerce web site for a given retailer (referred to herein as a retailer web server 404, for convenience).

As mentioned above, the content adaptation server 402 may be realized in a content server in a CDN. As such, the content adaptation server 402 may be servicing requests for multiple mobile clients, as well as working in conjunction with multiple retailer web servers 404 or other origin servers.

Generally, as shown in FIG. 4, the mobile client 400 makes requests for content from the content adaptation server 302. That content may include, for example, an HTML document representing a web page on the retailer's web site. (In some cases, the mobile client 402 will have received the IP address of the content adaptation server 402 by the DNS system of the CDN after initially making a request for a domain name associated with an origin server 406, as described above in connection with FIGS. 1-2.) The content adaptation server 402 adapts content from the retailer web server 404 for delivery to the particular mobile client that is requesting such content.

Turning to the information flow illustrated in FIG. 4, in step 1, the content adaptation server 402 receives a request for content from the mobile client 400. The content adaptation server 402 may check a local cache to determine if it already has the requested content and it has not expired. If so, the content can be delivered to the mobile client 402 from the cache. If not (or if the content adaptation server 302 is not configured for such caching), in step 2 the content server 400 issues a request in to the retailer web server 404 for the content, to which the retailer web server 404 responds in step 3. Before responding to the mobile client 402 in step 4, however, the content adaptation server 402 adapts the content for the mobile client 402 based on the characteristics of the mobile client 402.

To perform such adaptation, the content adaptation server 402 determines what device and/or browser is on the mobile client 402, and/or obtains information about the characteristics of the mobile client 402. This determination can come at least in part from the ‘user_agent’ string supplied by the mobile client 402 in the HTTP/HTTPS header of its request in step 1. The characteristics of the device and/or browser associated with the user_agent of the mobile client 402 are used to adapt content for display by that particular mobile client 402—also referred to as transcoding or “mobilizing” the content.

The process for transcoding the content may take a variety of forms, and the systems and methods disclosed herein are not limited to a particular technique. It may be performed in any conventional manner, as modified by the teachings hereof. For example, the layout of a requested web page may be adjusted and inline images resized/resampled/recolored in accordance with the display size and capabilities of the target device/browser. Video content may be replaced by representative frame captures. Unsupported content or tags may be omitted, or modified to a supported type (as certain devices/browsers do not support certain types of content, e.g., certain video formats). Content exceeding a threshold size may be blocked. In some cases, a single web page may be broken into multiple pages. Additionally, compression or other data reduction techniques may be employed in order to compensate for the generally slower network connection to the mobile client. The content adaptation server 402 may cache the adapted content internally so that subsequent requests may be serviced from its cache rather than repeating the adaptation exercise.

The content adaptation server 402 delivers the adapted content to the mobile client 400. That delivery may trigger (e.g., in the case of an mobilized HTML page) requests for additional content from the mobile client referenced therein, causing steps 1-4 to repeat.

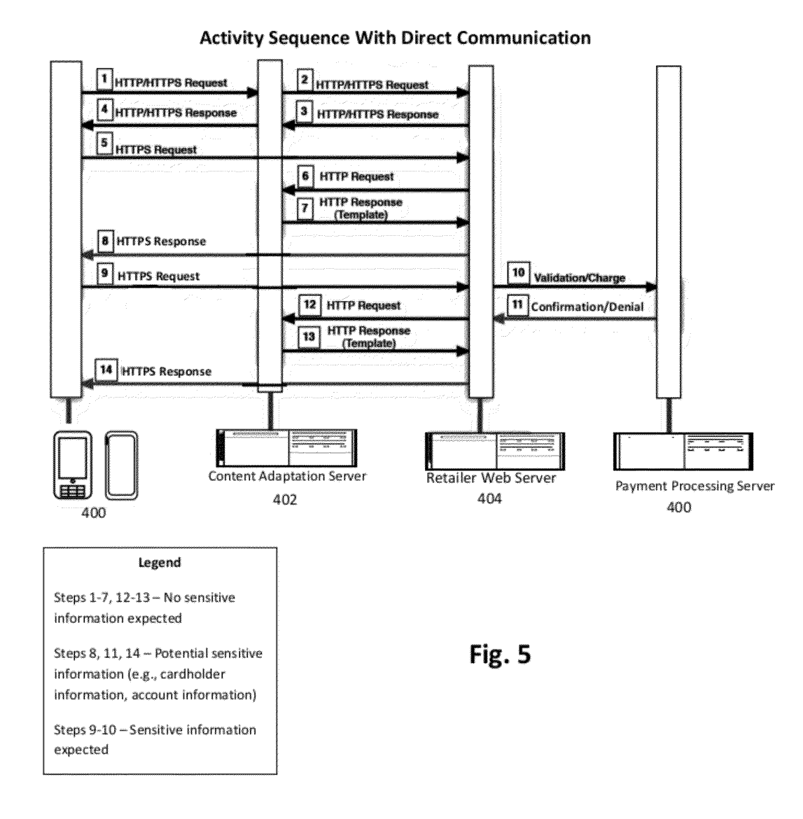

FIG. 5 illustrates the flow of data in the system when the mobile client will interact directly with the retailer web server 404 (e.g., because the content relates to a transaction involving sensitive information such as payment information, account information, as described above). The term ‘sensitive information’ is used to refer to information that is to be treated with different security standards or otherwise differently compared to non-sensitive information. As illustrated in FIG. 5, sensitive payment information is exchanged as part of a purchase/checkout procedure on a retailer's web site. For this transaction with sensitive information, a secure payment architecture comes into effect.

Steps 1-3 are the same as described in connection with FIG. 4. In Step 4, however, when the content adaptation server 402 detects a request for a payment form or other content that foreshadows the receipt of payment information from the mobile client 400, the content adaptation server 402 responds by redirecting (e.g., via an HTTP 301 or 302 response, or a HTML meta refresh) the mobile client 402 to the retailer web server 404. In other embodiments, the mobile client 400 may follow a link to a payment page that points to the retailer web server 404, instead of utilizing the redirect. The connection from the client to the retailer web server 404 may be effected using a secure protocol, such as SSL or TSL, whereas the connection to the content adaptation server may be a non-secure protocol.

In step 5, following redirection, the mobile client 400 sends the request for the payment form or other content to the retailer web server 404. At this point, however, the retailer web server 404 does not have a mobilized payment form for delivery to the mobile client 400.

In step 6, the retailer web server 404 sends a request to the content adaptation server 402 for a template that effects mobile-client specific formatting. In some cases, the request may ask for a predefined template (e.g., a “payment form template”, or a “receipt template,” etc.). Such templates include, for example, branding and navigation elements of a mobilized page optimized for the identified mobile client. Content, such as html, placed in the templates appears as if it is part of the rest of the mobile site. The templates may also, for example, define mobile-friendly display attributes through HTML meta tags, cascading style sheets, or other presentation-control constructs.

By way of illustration, a template may specify a page header differently depending on the screen size of the device for which the content is being adapted. The template may specify the use of an banner image reading “ABC Company” for a device with a larger size screen, but would specify another image, such as “ABC Co.” or simply “ABC”, for smaller screens, thus using version of the image that is best suited to the width of the screen. At the same time, the template might specify the display of a background image (e.g., an image that is a single pixel or just a few pixels wide and the same height as the banner) to be repeated across the width of the page behind the name, thereby presenting a seamless background on top of which the name can be displayed.

By way of further example, a template might set a value of the viewport attribute in an HTML meta tag to give the mobile browser information about the size of the page (e.g., 320 pixels in width). The browser is then able to scale the page appropriately, rather than, for example, assuming that the page has been designed for a desktop screen.

A template also can specify a type or version of a menu to use for the page, based on the content adaptation server's detection of the mobile client attributes and supported functionality. For example, the template can specify menu utilizing a version of javascript that is supported by the device.

The above examples are provided for illustration only and are not meant to be limiting. The techniques for assisting delivery of adapted content amongst servers, as described herein, are not limited to any particular template or adaptation technique.

In other cases, the retailer web server 404 may retrieve content that has already been adapted (e.g., a mobilized page) by sending a URL to the content adaptation server 402. The content adaptation server 402 responds with mobile-adapted content that it retrieved from its cache. In yet other cases the retailer web server 404 may send content, e.g., HTML, as part of the request, in effect requesting that the content adaptation server 402 adapt such submitted content into a mobile-client specific format. The request also identifies the mobile client 400 for which the template is to be targeted. However, the request does not include sensitive payment information, since the content adaptation server 402 is not handling such information.

In step 7, the content adaptation server 402 responds with a version of a template (e.g., in HTML code) that best fits the targeted mobile client 400. The content adaptation server 402 may generate that template by selecting it from a cached library and/or generating it based on the HTML or other content identified in the request. The template is generated based on known characteristics of the mobile client 400, such as its display capabilities, which can be obtained from the mobile device manufacturers or other known industry sources, such as the WURFL database.

In step 8, the retailer web server 404 adds any necessary sensitive information to the template. Such information may include credit card data, account information, personal information, or the like. The process of adding such information to the template typically involves inserting or appending data into the template, as will be described in more detail below. The combination of the template with the information added by the retailer web server 404 results in a response suitable for the retailer web server 404 to send to the mobile client 400. To continue the foregoing example, such a response might be a completed HTML payment form in a format adapted for display by the particular requesting mobile client 400.

In step 9, the user completes the payment form and the mobile client 400 sends the payment form directly to the retailer web server 404.

In step 10, the retailer web server 404 may initiate requests (credit card validation, etc.) to a machine 500 associated with a payment processor. That machine 500 issues a confirmation/denial as appropriate in step 11.

In steps 12-13, to inform the mobile client 400 about the result of the transaction (e.g., a receipt page, confirmation number, account balance, or the like), the retailer web server again requests and receives a template from the content adaptation server 402.

In step 14, the retailer web server 404 adds potentially sensitive information to the template and sends the result to the mobile client 400. Subsequent communications that involve payment information (or other sensitive information) follow the process outlined in steps 5-13. Once such information has been collected and processed, the retailer web server 404 redirects the mobile client 400 back to the content adaptation server 400 to resume the normal flow of content delivery shown in FIG. 4.

As result of the foregoing process, payment or other sensitive information does not touch the content adaptation server 402. At the same time, the mobile client 400 is consistently provided with mobile-adapted content because the content adaptation server 402 assists the retailer web server 304.

In other embodiments, firewalls may also be placed around the content adaptation server 402 and configured to reject all data matching or resembling a credit card number or other account number. As a result, the logs of the content adaptation server 402 will not contain such information, separating them from the portions of the system that process such information and are subject to data security regulations.

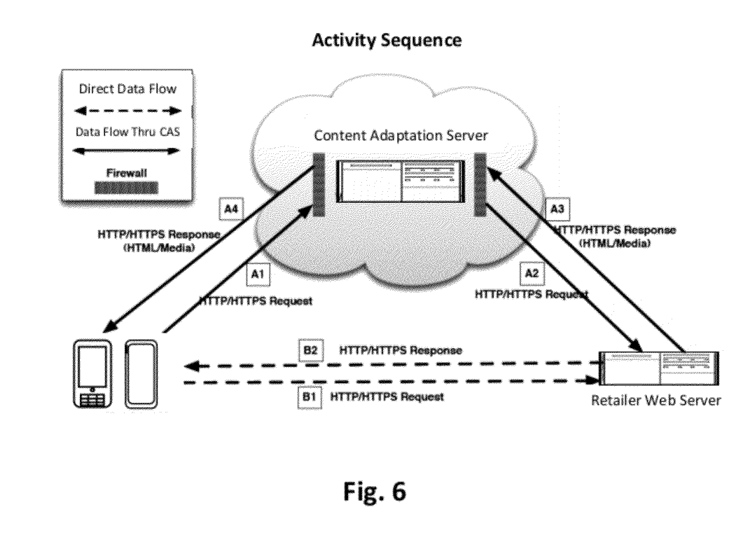

FIG. 6 is an alternate diagram of the typical flow of information in the system that was presented above in connection with FIG. 5, with the firewalls added. Steps A1-A4 correspond to steps 1-4, respectively, as illustrated and described above in connection with FIG. 5. Steps B1 and B2 represent direct communications (requests and responses) between mobile client and retailer web server. In FIG. 6, communications labeled A can be accomplished independently of those labeled B. The communications of A may be sent over a non-secure (HTTP) connection, while those of B may be sent over a secure (HTTPS/SSL) connection.

FIG. 7 is a diagram of the flow of information similar to FIG. 5 but in a modified system. The steps illustrated in FIG. 7 labeled with A track like-numbered steps as illustrated and described in connection with FIG. 5. However, in the system of FIG. 7, the retailer web server and payment processing server have been replaced with a managed environment that includes the payment processor (which maybe an outsourced function) and segregates retailer web server functions amongst multiple servers—namely, a web server 700 that serves the content of the web site and a secure server 702 that receives and processes sensitive information such as credit card data, account data, order management, etc. Communications may also flow between the web server 700 and the secure server 702, e.g., to provide notifications of completed sales or other information. The system illustrated in FIG. 7 thus restricts the use of sensitive information to the secure server 702 in order to provide increased separation between environments that handle sensitive information and those that do not.

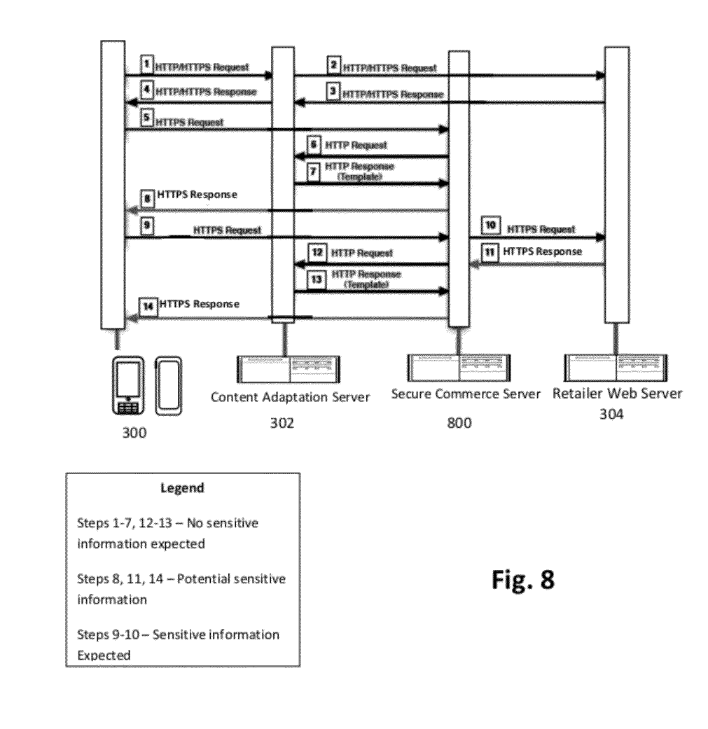

FIG. 8 illustrates the flow of sensitive information in an alternate embodiment of a system with both a content adaptation server 302 and a secure commerce server 800, both of which may be content servers in the CDN. In this embodiment, the secure commerce server 800 fulfills, in part, the role of the retailer web server 304 in FIG. 4. The secure commerce server 800 is configured with the appropriate security measures to be able to process sensitive information such as credit card data. The configuration illustrated in FIG. 7 permits the retailer web server 304 to reduce its load by offloading tasks to the content adaptation server 302 and the secure commerce server 800, collectively. At the same time, the content adaptation server 302 assists the secure commerce server 800 is providing mobilized content.

Steps 1-4 in FIG. 8 are the same as steps 1-4 described above in connection with FIG. 4. In step 4, however, when the content adaptation server 302 detects a request for a payment form or other content that foreshadows the receipt of payment information from the mobile client 300, the content adaptation server 302 responds by redirecting (e.g., via an HTTP 302 redirect or otherwise) the mobile client not to the retailer web server 304 but to the secure commerce server 800.

Steps 5-9 are the same as steps 5-9 described above in connection with FIG. 4, except that the secure commerce server 800 takes the place of the retailer web server 304, e.g., processing requests for payment-related content, issuing requests for mobilized content from the content adaptation server 302, adding sensitive information to the received templates, and responding to the mobile client 300. In steps 10-11, the secure commerce server 800 may request information from the retailer web server 304 and/or forward information about the transaction to the retailer web server 304, which can respond to the secure commerce server 800 as if the request were from a normal web browser. The secure commerce server 800 and/or the retailer web server 304 may also communicate with a payment or merchant processor to confirm or validate the transaction.

In steps 12-13, to inform the mobile client 300 about the result of the transaction (e.g., a receipt page, confirmation number, account information, or the like), the secure commerce server 800 again requests and receives a template from the content adaptation server 302.

In step 14, the secure commerce server 800 adds potentially sensitive information to the template and sends the result to the mobile client 300. Subsequent communications that involve payment or other sensitive information follow the process outlined in steps 5-13. Once such information has been collected and processed, the secure commerce server 800 redirects the mobile client back to the content adaptation server 300 to resume the normal flow of content delivery in steps 1-4.

The data flows described above also apply to systems in which the content adaptation server does not itself serve content to the mobile client, such as system C in FIG. 3. In such cases, requests for content are made directly to the retailer web server, and the content adaptation server merely assists in the background, providing templates or other mobilization information, as described for example in connection with steps 5-14 in FIG. 5.

2.2 Session Integration

The content adaptation server and the server(s) being assisted in communicating with the mobile client (for example, the origin server/retailer web server 304 in the foregoing Figures being an assisted server) preferably integrate their sessions with a given mobile client, handing off the session to one another as the user navigates a web site. Session handoffs can occur, for example, in steps 4 and 14 of FIG. 4. Session handoff can involve both redirection to/from the content adaptation server and the assisted server, as well as the transfer of session state information (e.g., cookies) between them during the handoff.

2.2.1 Overview

In one embodiment, there are three parts to the interface between the content adaptation server and the assisted server: (1) session handoff to assisted server; (2) content adaptation server web services; (3) session handoff to the content adaptation server. The handoffs are covered next; the web services are described in the section below entitled WEB SERVICES API.

2.2.2 Session Handoffs & Redirection

The session handoff directs the mobile client to the appropriate web page and also transfers cookie data between the content adaptation server and the assisted server.

In embodiments utilizing an HTTP redirect function, as discussed previously, the assisted server can be associated with a redirection endpoint URL. Clients will be serviced by the content adaptation server until there is a need for redirection. In the foregoing examples, this occurs when a mobile client encounters a payment form or other content that foreshadows the receipt of payment or other sensitive information from the mobile client. At this point, the client is redirected to the assisted server's specified endpoint.

2.2.3 Cookie Management

The names of the cookies required by the assisted server for session handoff may be supplied to the content adaptation server beforehand.

Many mobile devices have limited support for cookies. For this reason, the content adaptation server may proxy some of the cookies sent by the desktop site as the end user navigates the mobile-adapted site.

The proxied cookies are made available to the assisted server during session handoff. Changes to the cookies that occur while the assisted server is servicing the mobile client are communicated back to the content adaptation server once the session is handed back and/or the session has ended.

2.2.4 Session Transfer to Assisted Server

In one embodiment, at the time when the user is being redirected to the assisted server, the following parameters are appended to the request for the endpoint URL.

| Parameter | Description |
|---|---|
| cookies | The proxied cookies from the domain, in the |
| | format of the cookie HTTP request header |
| session_id | The session ID |

The cookies parameter contains the proxied cookies in the form of the standard HTTP request Cookie header. These cookies represent a preselected subset of the cookies that the end user would have accumulated had they been browsing directly on the assisted server.

The session_id can be used to read and alter the proxied cookies using the session web service.

Session Transfer to Content Adaptation Server

When the sensitive part of the transaction has completed, the assisted server can return the mobile client to the content adaptation server by directing the user back to a prearranged URL or a URL retrieved from the redirect web service.

Cookies changes should be propagated back to the content adaptation server. The redirect back to the content adaptation server provides one way to set these values. There can also be a web service for altering the shared cookie immediately, rather than only at redirect time.

In one embodiment, the cookie values are updated by passing the following parameter to the redirection URL:

| Parameter | Description |
|---|---|
| see_cookie | The new value of the cookies in the format of an |
| | HTTP response Set-Cookie header. |

The proxied cookie values will be set to the new value.

Information other than that stored in cookies or session variables may be collected by the content adaptation server and transferred between the content adaptation server and assisted server. Any information collected from the user or assisted server that is necessary to the transaction may be passed back and forth. For example, in one embodiment, the content adaptation server may receive information from a web form completed by the user, as it will be posted to the content adaptation server. This information can be collected and transferred to the assisted server in conjunction with the handoff. A user may complete part of a form (i.e., the part with the non-sensitive information), and the session can be transferred to the assisted server to complete the remainder of the form (or a separate form) that calls for sensitive information such as a credit card number, which can only be handled by the PCI-compliant assisted server.

2.3 Web Services API

In one exemplary embodiment, the content adaptation server can provide a suite of web services to provide the functionality described herein.

The web services provides universal resource locators (URLs) to which an assisted server can make requests in a manner known in the art. For example, a service may be invoked at the URL of http://mobile<dot>contentadaptationserver<dot>net/API_service_name/parameters. A variety of services may be invoked and are described below.

Parameters may include such things as the target device (e.g., user agent) of the device to service, an API access key (e.g., issued by the content adaptation server to control access to the system and identifying assisted servers so as to ensure that session data and templates from one retailer are not available to another), and authentication keys (e.g., a security key generated using conventional security mechanisms.

Templates

Although a variety of techniques may be used for providing mobilization information, in one embodiment, a request for mobilization information such as a template may be made to the service at the request URL by including a template name in the parameter list. Predefined templates may be provided, such as the templates WRAPPER, HEADER, FOOTER, and RETURN. Custom templates such as “checkout” or “receipt” or “inventory page” or “account home page” may be defined by a particular content provider. Requests sent to the URL for a particular template with the appropriate target device and key parameters, can be responded to with a template adapted for the specified device.

Templates may be implemented in a variety of ways, but in one implementation, the template can be a Jasper template that contains placeholder variables in a format such as form: [[VARIABLE_NAME]]. The variable placeholders in the template will vary with the individual template.

The WRAPPER template can be used to wrap content, such as an html page, for mobile display. A template may contain cascading style sheet, meta tags, or other presentation-control constructs to define mobile-friendly display attributes, e.g., as previously discussed.

A wrapper template may use variables such as: TITLE (the title of the page) and BODY (the content of the page). Thus, the wrapper template can contain branding and navigation elements of a mobilized page into which text or other content can be inserted (by the assisted server) to create a complete mobilized page.

In some implementations, multiple content variables (e.g., BODY_1, BODY_2) may be employed for complex templates, allowing the insertion of content into multiple points in the template.

The HEADER template contains just the header portion of the WRAPPER template. It uses a single variable: TITLE (the title of the document). The FOOTER template contains just the footer portion of the WRAPPER template and uses no variables.

Generating a simple page with the web services templates can be achieved in accordance with the following exemplary procedure:

1. Requesting the template at http://mobile<dot>contentadaptationserver<dot>net/APIcommand_name/WRAPPER and replacing [[TITLE]] with the page title and [[BODY]] with the page body.

Alternatively, the same result can be achieved by:

1. Requesting the template at http://mobile<dot>contentadaptationserver<dot>net/APIcommand_name/HEADER and replacing [[TITLE]] with the page title,
2. Appending the body of the document,
3. Appending the template at http://mobile<dot>contentadaptationserver<dot>net/APIcommand_name/FOOTER

The RETURN template contains a link back to the content adaptation server for optional use when the assisted server activity is finished. It uses three variables: TITLE (the title of the page); BODY (the content of the page); COOKIES (the new cookies to set within the content adaptation server cookie proxy).

The replacement of variable placeholders with the variable values can be achieved either though use of such mechanisms as the Jasper templating framework or through text substitution, or otherwise as known in the art.

Jasper

In the foregoing example, templates returned from the template web service are in Jasper format. In other implementations, alternate web templating frameworks can be employed (e.g., JavaServer pages, active server pages (ASP), hypertext preprocessor (PHP) can be used). The Jasper format was designed as a cross-platform template language. As one skilled in the art will recognize, there are libraries for processing Jasper in Java, ASP, PHP, and Perl that can be used.

Jasper templates consist of text with embedded directives. The directives used in this implementation are all variable references. These are names of variables surrounded by double square brackets. The variable named “animal” would be expressed as: [[animal]]

Consider the following template: “The quick brown [[animal]] jumps over the lazy dog.” This template be rendered as follows if the value of “animal” is “fox”: “The quick brown fox jumps over the lazy dog.” String replacement can be used to fill in the necessary variable values. More information can be found online at http://jasper<dot>mygarble<dot>com/

Mobile Redirect

To send the mobile client back to the content adaptation server (e.g., after all of the sensitive information has been transferred and normal flow is to resume, see, e.g., step 14 of FIG. 4, described above), the assisted server can use a mobilized redirect URL. The mobilized redirect URL can be predetermined. The mobilized redirect URL can also come from a value in a mobile template, e.g., a value returned in or in conjunction with a template to the assisted server, thus providing explicit configuration as part of the mobile engagement process. Alternatively, the assisted server can request a mobilized URL from the content adaptation server and use that to respond to the mobile client.

Device Capabilities

There may be cases where the existing templates do not entirely fit the needs of a particular page. In these cases it is possible for the assisted server to directly query device characteristics from the content adaptation server. For example, the assisted server can make a request to the web services API for the parameters of a particular device, specifying the format for the response. The response will contain the same data regardless of the response format. The fields will be sent in the requested format, for example:

| response_format | Example Response |
|---|---|
| json | { “max_image_width”: “92” } |
| pairs | max_image_width=92 |
| xml | <device:max_image_width>92 |
| | </device:max_image_width> |

In this example, the field is max_image_width, which indicates the maximum image width in pixels for a given mobile client. When displaying images in the BODY of the wrapper, or between the HEADER and FOOTER templates, respecting the max_image_width value will result in an improved user experience.

The web service can return a variety of device characteristics. For example:

| Field | Description |
|---|---|
| Name | The device name |
| Width | The width of the screen |
| Height | The height of the screen |
| Class | The device class (e.g., by manufacturer, OS, etc.) |
| Max_image_width | The maximum image width safe for display on the |
| | device |
| Max_image_height | The maximum image height safe for display on the |
| | device |

Widths and heights can be reported in pixels or other metric. Device capability entries will change over time as new devices and device versions are added.

Session Retrieval

The initial redirection from the content adaptation server to the assisted server can contain several parameters, as described above in connection with Session Integration. As noted, one of these parameters is the session_id parameter. Should the assisted server need to query the state of the end user's session, it may transmit a request to the web services (using the appropriate API command name) to the content adaptation server to retrieve the user's cookies for a particular session.

A request sent to the session retrieval service will receive a response containing the parameters that would have been sent with the initial redirect to the assisted server as described in the Session Integration. Such a service is advantageous in situations where the initial redirect is sent to a page that cannot make use of the cookie values. A page deeper in the processing chain may request those values from the content adaptation server to simplify development.

Session Modification

The redirection from assisted server to the content adaptation server can contain several parameters for session restoration, as described previously in connection with Session Integration. Should the assisted server need to modify the shared session data outside of the return redirect, changes can be effected by posting new values to a session modification service URL such as http://mobile<dot>contentadaptationserver<dot>net/API_session_modification/parameters with a session identifying parameter. In this way, a POST request sent to the session modification service can modify the stored session for the end-user. Such a service may be used to set new values for cookies that have changed in the session. This may occur in situations where there is transient data (such as shopping cart contents) stored in cookie values. After checkout, such cookies may need to be cleared or modified. Although a post-checkout redirect to the content adaptation server can provide one way to set these values, this service permits the values to be set immediately, rather than only at redirect time.

3.0 Implementation

The clients, servers, and other devices described herein may be implemented on conventional computer systems, as modified by the teachings hereof, with the functional characteristics described above realized in software, hardware, or a combination thereof.

Software may include one or several discrete programs. Any given function may comprise part of any given module, process, execution thread, or other such programming construct. Generalizing, each function described above may be implemented as computer code, namely, as a set of computer instructions, for performing the functionality described via execution of that code using conventional means, e.g., a processor, a computer, a machine, a system, digital data processing device, or other apparatus. In one embodiment, such software may be implemented in a programming language that runs in conjunction with a DNS-compliant name server (e.g., BIND).

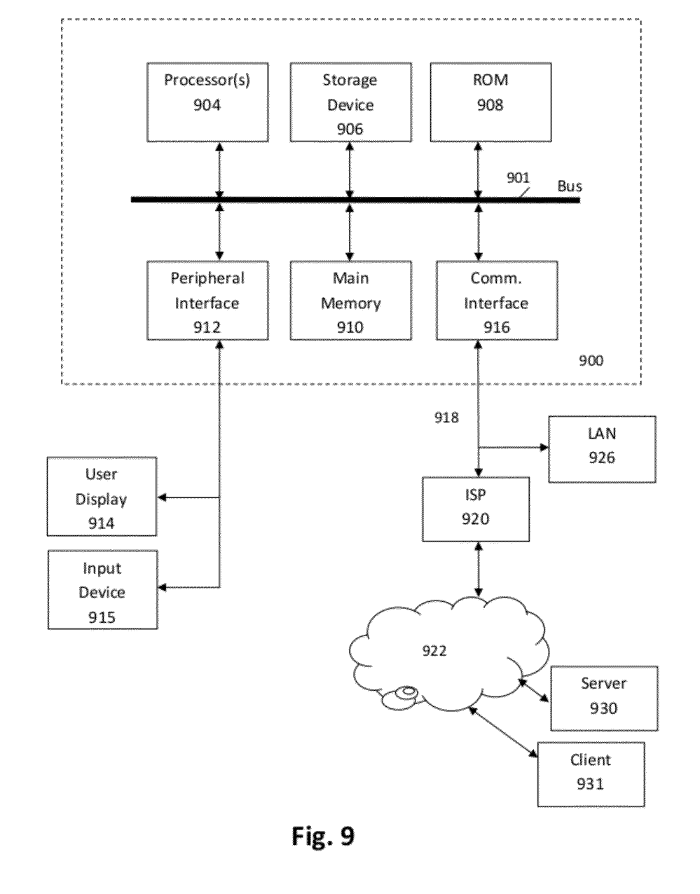

FIG. 9 is a block diagram that illustrates hardware in a computer system 900 upon which such software may run in order to implement embodiments of the invention. The computer system 900 may be embodied in a client device, server, personal computer, workstation, tablet computer, wireless device, mobile device, network device, router, hub, gateway, or other device.

Computer system 900 includes a processor 904 coupled to bus 901. In some systems, multiple processor and/or processor cores may be employed. Computer system 900 further includes a main memory 910, such as a random access memory (RAM) or other storage device, coupled to the bus 901 for storing information and instructions to be executed by processor 904. A read only memory (ROM) 908 is coupled to the bus 901 for storing information and instructions for processor 904. A non-volatile storage device 906, such as a magnetic disk, solid state memory (e.g., flash memory), or optical disk, is provided and coupled to bus 901 for storing information and instructions. Other application-specific integrated circuits (ASICs), field programmable gate arrays (FPGAs) or circuitry may be included in the computer system 900 to perform functions described herein.

A peripheral interface 912 communicatively couples computer system 900 to a user display 914 that displays the output of software executing on the computer system, and an input device 915 (e.g., a keyboard, mouse, trackpad, touchscreen) that communicates user input and instructions to the computer system 900. The peripheral interface 912 may include interface circuitry, control and/or level-shifting logic for local buses such as RS-485, Universal Serial Bus (USB), IEEE 1394, or other communication links.

Computer system 900 is coupled to a communication interface 916 that provides a link (e.g., at a physical layer, data link layer, or otherwise) between the system bus 901 and an external communication link. The communication interface 916 provides a network link 918. The communication interface 916 may represent a Ethernet or other network interface card (NIC), a wireless interface, modem, an optical interface, or other kind of input/output interface.

Network link 918 provides data communication through one or more networks to other devices. Such devices include other computer systems that are part of a local area network (LAN) 926. Furthermore, the network link 918 provides a link, via an interne service provider (ISP) 920, to the Internet 922. In turn, the Internet 922 may provide a link to other computing systems such as a remote server 930 and/or a remote client 931. Network link 918 and such networks may transmit data using packet-switched, circuit-switched, or other data-transmission approaches.

In operation, the computer system 900 may implement the functionality described herein as a result of the processor executing code. Such code is typically read from or provided by a non-transitory computer-readable medium, such as memory 910, ROM 908, or storage device 906. Other forms of non-transitory computer-readable media include disks, tapes, magnetic media, CD-ROMs, optical media, RAM, PROM, EPROM, and EEPROM. Any other non-transitory computer-readable medium may also be employed. Executing code may also be read from network link 918 (e.g., following temporary storage in an interface buffer, local memory, or other circuitry).

What is claimed is:

1. A computerized method for delivering content to a mobile client, comprising:
receiving, from a first content server that is responding to a request for content from a mobile client, a request for information that can be used to provide the requested content to the mobile client in a format adapted for display by the mobile client (“mobilization information”), where the request for mobilization information is received at a second content server and includes information identifying the mobile client or one or more characteristics thereof;
with the second content server, generating the mobilization information based on one or more characteristics of the mobile client;
sending the mobilization information to the first content server, so as to enable the first content server to provide the requested content to the mobile client in a format adapted for display by the mobile client.

2. The method of claim 1, further comprising:
receiving a request for content from the mobile client at the second content server;
with the second content server,
obtaining content responsive to the request;
adapting the responsive content for the mobile client, based on one or more characteristics thereof; and
serving the adapted content to the mobile client.

3. The method of claim 2, wherein the content requested by the mobile client from the first content server comprises confidential information from a website and the content requested by the mobile client from the second content server comprises non-confidential information from the website.

4. The method of claim 3, wherein the website is an e-commerce website and the confidential information comprises payment information for an e-commerce transaction.

5. The method of claim 4, wherein the first content server is qualified to process payment information and the second content server is not qualified to process payment information.

6. The method of claim 1, wherein the first content server is associated with a first content provider and the second content server is associated with a service provider that provides a content adaptation service to a plurality of content providers, and further comprising:
receiving, from another content server that is associated with another content provider and that is responding to a request for content from a mobile client, a request for information that can be used to provide the requested content to the mobile client in a format adapted for display by the mobile client (“mobilization information”), where the request for mobilization information provides information about the mobile client and is received at the second content server;
with the second content server, generating the mobilization information based on one or more characteristics of the mobile client;
sending the mobilization information to the another content server, so as to enable the another content server to provide the requested content to the mobile client in a format adapted for display by the mobile client.

7. The method of claim 1, wherein the mobilization information comprises a template into which the first content server can insert information to form a response to the mobile client.

8. (canceled)

9. The method of claim 7, wherein generating the template comprises any of (i) creating a template based on one or more characteristics of the mobile client and (ii) selecting the template from a set of stored templates based on one or more characteristics of the mobile client.

10. The method of claim 1, wherein the mobile client comprises a smartphone.

11. The method of claim 1 wherein the request for the mobilization information further includes content to be adapted for display by the mobile client, and further comprising: with the second content server, adapting the content included in the mobilization information request for the mobile client and sending it to the first content server.

12. Computer apparatus for delivering content to a mobile client, comprising:
circuitry forming one or more processors;
memory storing instructions that, when executed by the one or more processors, will cause the computer apparatus to perform the following steps:
receiving, from a first content server that is responding to a request for content from a mobile client, a request for information that can be used to provide the requested content to the mobile client in a format adapted for display by the mobile client (“mobilization information”), where the request for mobilization information includes information identifying the mobile client or one or more characteristics thereof;
generating the mobilization information based on one or more characteristics of the mobile client;
sending the mobilization information to the first content server, so as to enable the first content server to provide the requested content to the mobile client in a format adapted for display by the mobile client.

13. The apparatus of claim 12, wherein the steps further comprise:
receiving a request for content from the mobile client;
obtaining content responsive to the request;
adapting the responsive content for the mobile client, based on one or more characteristics thereof; and
serving the adapted content to the mobile client.

14. The apparatus of claim 13, wherein the content requested by the mobile client from the first content server comprises confidential information from a website and the content requested by the mobile client from the apparatus comprises non-confidential information from the website.

15. The method of claim 14, wherein the website is an e-commerce website and the confidential information comprises payment information for an e-commerce transaction.

16. The method of claim 15, wherein the first content server is qualified to process payment information and the apparatus is not qualified to process payment information.

17. The apparatus of claim 12, wherein the first content server is associated with a first content provider and the apparatus is associated with a service provider that provides a content adaptation service to a plurality of content providers, and wherein the steps further comprise:
receiving, from another content server that is associated with another content provider and that is responding to a request for content from a mobile client, a request for information that can be used to provide the requested content to the mobile client in a format adapted for display by the mobile client (“mobilization information”), where the request for mobilization information provides information about the mobile client;
generating the mobilization information based on one or more characteristics of the mobile client;
sending the mobilization information to the another content server, so as to enable the another content server to provide the requested content to the mobile client in a format adapted for display by the mobile client.

18. The apparatus of claim 12, wherein the mobilization information comprises a template into which the first content server can insert information to form a response to the mobile client.

19. (canceled)

20. The apparatus of claim 18, wherein generating the template comprises any of (i) creating a template based on one or more characteristics of the mobile client and (ii) selecting the template from a set of stored templates based on one or more characteristics of the mobile client.

21. The apparatus of claim 12, wherein the mobile client comprises a smartphone.

22. The apparatus of claim 12 wherein the request for the mobilization information further includes content to be adapted for display by the mobile client, and wherein the steps further comprise adapting the content included in the mobilization information request for the mobile client and sending it to the first content server.

23.-58. (canceled)
